(19) United States
(12) Patent Application Publication
(10) Pub. No.: US 2011/0198674 A1
(43) Pub. Date: Aug. 18, 2011

(54) GAS-SENSITIVE FIELD EFFECT TRANSISTOR AND METHOD FOR MANUFACTURING A GAS-SENSITIVE FIELD EFFECT TRANSISTOR

(76) Inventors: Andreas Krauss, Tuebingen (DE); Martin Le-Huu, Korntal (DE)

(21) Appl. No.: 13/012,596

(22) Filed: Jan. 24, 2011

(30) Foreign Application Priority Data
Feb. 16, 2010 (DE) 102010001998.4

(51) Int. Cl. G01N 27/414; G01N 27/403

(52) U.S. Cl. 257/253; 438/49; 257/E21.19; 257/E29.255

(57) ABSTRACT

A gas-sensitive field effect transistor is described which includes a semiconductor substrate having a main substrate surface. The semiconductor substrate has a source region, a gate region, and a drain region. The field effect transistor also includes an insulating layer which has a first main surface facing the main substrate surface, and a second main surface facing away from the main substrate surface. The insulating layer at least partially covers the main substrate surface, and in the area of the gate region has an opening or a region having reduced layer thickness having beveled side walls. An area of the opening in the second main surface is larger than an area of the opening in the first main surface. Lastly, the field effect transistor includes a gate electrode layer which covers at least a partial region of the first main surface of the insulating layer, a region of the beveled side walls of the opening, and an area of the gate region. The gate electrode layer includes a material or a structuring which causes a change in the electrical properties of the gate electrode layer upon contact with a predefined gas.

### CROSS REFERENCE

The present application claims the benefit under 35 U.S.C. §119 of German Patent Application No. DE 102010001998.4, filed on Feb. 16, 2010, which is expressly incorporated herein by reference in its entirety.

### FIELD OF THE INVENTION

The present invention relates to a gas-sensitive field effect transistor, and a method for manufacturing a gas-sensitive field effect transistor.

### BACKGROUND INFORMATION

In current gas-sensitive or chemosensitive field effect transistors (also often abbreviated as “CHEMFETs”), which are designed for adverse environmental conditions (also referred to as “harsh environments”) and which must therefore withstand high temperatures or severe chemical stress, a wide bandgap semiconductor material (SIC or GaN, for example) is typically used as a semiconductor substrate. A chemically sensitive, electrically conductive layer, which in particular is also applied to the channel region of the FET, is contacted very near to or on the channel region. The channel region is provided with only a thin insulation “gate oxide” (which actually represents gate insulation, since other insulation materials are also possible); the region further to the outside is generally protected by thicker insulation, a so-called “field oxide” (which also includes materials other than an oxide), and passivation. Because the properties of the field oxide (edges, for example) are generally not defined, the field oxide cannot be used as a base for a coating. In the conventional design, the gate electrode is therefore contacted on the gate oxide, next to or on the channel region, using a printed conductor which is guided up to the gate oxide, through or next to the channel, and is situated outside the channel region, on the field oxide or between the field oxide and the passivation. The contacting on the gate oxide limits the available methods for applying and structuring a printed conductor.

### SUMMARY

In accordance with the present invention, an example gas-sensitive field effect transistor, and a corresponding method for manufacturing a gas-sensitive field effect transistor are provided.

In accordance with the present invention, the example gas-sensitive field effect transistor has the following features:
a semiconductor substrate having a main substrate surface, the semiconductor substrate having a source region, a gate region, and a drain region;
an insulating layer which has a first main surface facing the main substrate surface, and a second main surface facing away from the main substrate surface, the insulating layer at least partially covering the main substrate surface, and in the area of the gate region having an opening or an insulating layer region having reduced layer thickness, and the insulating layer having beveled side walls in the region of the opening or in the insulating layer region, in such a way that a distance between oppositely situated beveled side walls of the insulating layer in the region of the opening or in the insulating layer region decreases from the second main surface toward the first main surface; and
a gate electrode layer which covers at least a partial region of the second main surface of the insulating layer, a region of the beveled side walls, and an area of the gate region, the gate electrode layer including a material or a structuring which causes a change in the electrical properties of the gate electrode layer or the surface thereof upon contact with a predefined gas.

In addition, in accordance with the present invention, the example method for manufacturing a gas-sensitive field effect transistor including the following steps:
providing a semiconductor substrate having a main substrate surface, the semiconductor substrate having a source region, a gate region, and a drain region, and the main substrate surface being covered by an insulating layer;
applying a masking layer to an exposed surface of the insulating layer, the masking layer being applied in such a way that it has a recess or opening having beveled side walls, the recess or opening tapering toward a region oppositely situated from the gate region;
forming an opening or a region having reduced layer thickness in the insulating layer, using the recess or opening, in such a way that an opening or an insulating layer region having reduced layer thickness is formed in the insulating layer, the insulating layer having beveled side walls in the region of the opening or in the insulating layer region, in such a way that a distance between oppositely situated beveled side walls of the insulating layer in the region of the opening or in the insulating layer region decreases from the second main surface toward the first main surface; and
applying a gate electrode layer in order to cover at least a partial region of the exposed main surface of the insulating layer, a region of the beveled side walls in the insulating layer, and an area of the gate region through the gate electrode layer, the gate electrode layer including a material or a structuring which causes a change in the electrical properties of the gate electrode layer or the surface thereof upon contact with a predefined gas.

A semiconductor substrate may be understood to mean a doped semiconductor material, the correspondingly named regions in this semiconductor substrate referring to specific increased dopings. The gate electrode layer may be used on the one hand for contacting, and on the other hand for forming a gate electrode itself. The gate electrode layer should include a material whose electrical properties or those of its surface change upon contact with a predefined gas, thus providing the gas sensitivity of the field effect transistor. The insulating layer may be formed by a layer made of an oxide or another insulating material.

According to the present invention, for manufacturing the field effect transistor, an opening or a region having reduced layer thickness and having beveled side walls is provided or formed in the insulating layer. For example, an opening area oppositely situated from the main substrate surface is smaller than an opening area which is formed in a main surface of the insulating layer facing away from the main substrate surface. In other words, a distance between oppositely situated beveled side edges of the insulating layer in the region of the opening or in the insulating layer region is larger in the vicinity of the second main surface than in the vicinity of the first main surface. This allows very precise, fine structuring of the gate electrode layer having the gas-sensitive property.

The present invention offers the advantage that there is no longer a concern for undefined or less precise contacting of the gate region of the field effect transistor during manufacture thereof as a result of the beveled side walls. Instead, due to the ramped shape of the opening or in the region having the reduced layer thickness, defined deposition and/or structuring of a layer on the insulating layer or the field oxide may be carried out in the field oxide (i.e., the insulating layer). The ramped shape of the opening in the insulating layer or in the insulating layer region having the reduced layer thickness tapers from a side facing away from the semiconductor substrate toward a side facing the semiconductor substrate. The beveled side walls then allow the use of simple methods for applying layers to the field effect transistor to be manufactured, which are cost-effective but still allow precise, fine structuring of the layer to be applied.

According to one advantageous specific embodiment of the present invention, the insulating layer may have beveled side walls which form an angle of 5 to 80 degrees with respect to the first or second main surface. Such a specific embodiment of the present invention offers the advantage that precise deposition and/or structuring of the insulating layer, and therefore a correspondingly more reliable design and contacting of the gate electrode, is possible within this angular range.

It is also advantageous when the source region, the drain region, and/or the gate electrode layer is/are electrically contacted with the aid of printed conductors which are applied to the second main surface of the insulating layer. Such a specific embodiment of the present invention offers the advantage that printed conductors may be applied to the exposed surface of the insulating layer. In this way, structures in the semiconductor substrate are protected from damage which might otherwise occur during the application of printed conductors directly to the semiconductor substrate or to the insulation of the gate region.

According to another specific embodiment of the present invention, a bond ring may also be provided which is situated on the side of the insulating layer facing the second main surface of the insulating layer, and which surrounds the opening in the insulating layer or the insulating layer region having reduced layer thickness in the insulating layer. Such a specific embodiment of the present invention offers the advantage that the gas to be measured may be led to the gate electrode layer using the bond ring, which advantageously provides a fluid- and gas-tight seal between a region of the opening in the insulating layer and a further region on the second main surface of the insulating layer. This ensures that the maximum possible amount of the gas to be measured is led to the gate electrode layer, so that the gate electrode layer also allows the most precise determination of the gas concentration possible.

To achieve optimal electrical contacting of the gate electrode layer, the bond ring may also include an electrically conductive material, and may be used as an electrical contact for the gate electrode layer.

According to another specific embodiment of the present invention, a carrier substrate may be provided which, in particular with the aid of flip-chip technology, is situated on a side facing the second main surface having the insulating layer, or on a structure which is mounted on the insulating layer, the carrier substrate being designed to mechanically retain the field effect transistor. Such a specific embodiment of the present invention offers the advantage that stable retention may be provided by the carrier substrate. In this way, on the one hand a thinner and therefore lighter semiconductor substrate may be used, thus allowing costs to be reduced, and on the other hand, also during formation of layers of the field effect transistor, the focus may be directed to the maximum optimal gas sensitivity of the layers or the layer sequence.

It is particularly advantageous when the carrier substrate has an opening which is oppositely situated from the opening in the insulating layer or the insulating layer region having the reduced layer thickness. Such a specific embodiment of the present invention offers the advantage that the carrier substrate may be applied to a composite composed of the semiconductor substrate, insulating layer, and gate electrode layer in such a way that the gate electrode layer is accessible only through the opening in the carrier substrate. This provides a great protection of the gate electrode layer from mechanical damage, and therefore increases the robustness of the gas-sensitive field effect transistor to be manufactured.

According to one particular specific embodiment of the present invention, the opening in the carrier substrate may be closed using a gas-permeable filter material or a catalyst material which is designed to filter or catalyze, respectively, a gas flowing through the opening in the carrier substrate. Such a specific embodiment of the present invention offers the advantage that on the one hand, damage to the gate electrode layer by a corrosive or undesired gas or particles in the gas may be largely prevented, and on the other hand the catalyst material may possibly convert a second gas to the predefined gas to which the gate electrode layer is sensitive, so that the manufactured field effect transistor may be used for different types of gas due to the simple closing of the opening by an appropriate catalyst material.

### BRIEF DESCRIPTION OF THE DRAWINGS

The present invention is explained in greater detail as an example, with reference to the figures.

FIG. 1 shows a top view illustration of a semiconductor structure of a gas-sensitive field effect transistor according to one exemplary embodiment of the present invention.

FIG. 2 shows a cross-sectional illustration of a semiconductor structure of a gas-sensitive field effect transistor according to one exemplary embodiment of the present invention, illustrating contacting of the gas-sensitive field effect transistor via a bond ring and/or flip-chip contacts.

FIG. 3 shows a cross-sectional illustration of a semiconductor structure of the gas-sensitive field effect transistor according to another exemplary embodiment of the present invention, likewise illustrating contacting of the gas-sensitive field effect transistor via a bond ring and/or flip-chip contacts.

FIG. 4 shows a flow chart of one exemplary embodiment of the present invention as a method.

### DETAILED DESCRIPTION OF EXAMPLE EMBODIMENTS

Identical or similar elements may be denoted by identical or similar reference numerals in the figures, and therefore the description is not repeated. In addition, the figures of the figures, and the description thereof contain numerous features in combination. These features may also be considered individually, or combined to form further combinations not explicitly described herein. Furthermore, the present invention is explained in the following description using various measurements and dimensions; the present invention is not to be construed as being limited to these measurements and dimensions. Moreover, method steps according to the present invention may be carried out repeatedly, as well as in a sequence other than that described. An exemplary embodiment which includes an “and/or” conjunction between a first feature/step and a second feature/step may be construed in such a way that according to one specific embodiment, the exemplary embodiment includes the first feature/first step as well as the second feature/second step, and according to another specific embodiment includes only the first feature/step or only the second feature/step.

According to the present invention, it is possible to simplify the design of a CHEMFET (i.e., a chemosensitive or gas-sensitive field effect transistor) for a harsh environment, and to improve and simplify the processing. In addition, the present invention allows protective measures for the gate insulation to be taken during the processing, and allows simplified connection of the chemosensitive or gas-sensitive FET die (i.e., the semiconductor component) in or on a housing or carrier substrate.

For example, the following measures may be carried out in the present invention:
The field oxide or the thicker insulation is provided with defined edge angles at the flanks for the gate insulation. In this manner the coating may also be continued up to the field oxide and used on same.
The gate oxide-field oxide transition is situated close to the boundary, preferably just outside the channel region.
The printed conductors are provided only on the field oxide, so that the contacting of the electrically conductive layer (gate electrode layer) is likewise situated on the field oxide.
The above-mentioned characteristic allows the gate oxide for the processing of the printed conductors and for the passivation to be protected during the processing, in which a cover layer (polysilicon, for example) is deposited, for example as a stop layer for dry etching processes, on the gate oxide. This layer may also remain on the gate oxide during the further processing of the semiconductor components, and is able to protect the gate oxide until the sensitive layer (i.e., the gate electrode or gate electrode layer) is applied.

In addition, using the design described in detail below, it is possible to implement an assembly and connection technology concept for CHEMFETs in which only the parts of the sensor which are necessary for the gas interaction are exposed, and all other parts are covered.

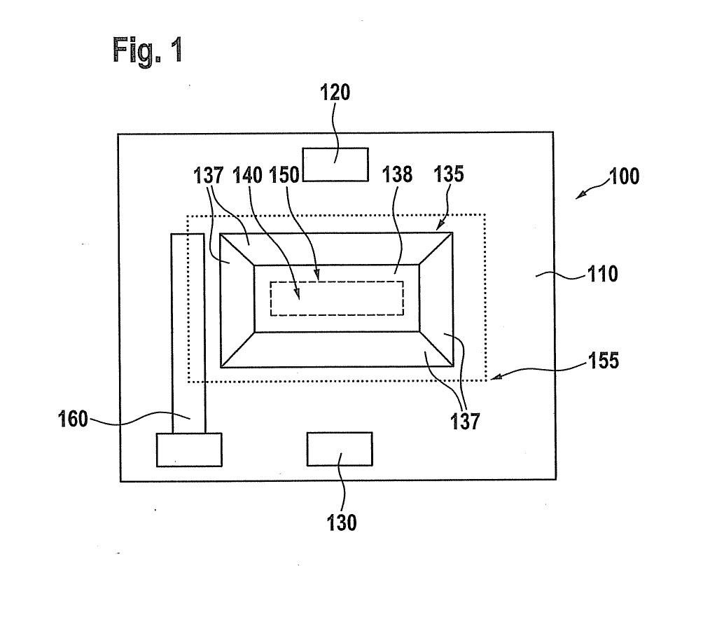

FIG. 1 shows a top view illustration of a semiconductor structure of a gas-sensitive field effect transistor 100 according to one exemplary embodiment of the present invention, illustrating connections for the source region and the drain region. FIG. 1 illustrates an insulating layer 110, which covers a semiconductor substrate which is only partially visible in the figure. Insulation layer 110 has a first opening 120 for connecting a source region in the semiconductor substrate situated therebeneath, and a second opening 130 for connecting a drain region in the semiconductor substrate of field effect transistor 100 situated beneath insulating layer 110. Insulation layer 110 may be made, for example, of silicon dioxide produced from tetraethyl orthosilicate (TEOS) and having a thickness of 300 nm to 500 nm. A third opening 135 having defined beveled side walls 137 is provided between first opening 120 and second opening 130, as described in greater detail below. Alternatively, it is not necessary to form a continuous opening through insulating layer 110 at the location of third opening 135; rather, instead of third opening 135, it is sufficient to provide a region having a reduced thickness of insulating layer 110, whereby the region having a reduced insulating layer thickness should likewise have beveled side walls. For simplicity, in the following description the present invention is generally described on the basis of an exemplary embodiment having an opening instead of a region of reduced thickness of insulating layer 110. These defined side walls 137 have a defined flank angle with respect to the surface of insulating layer 110, visible in FIG. 1. In the middle of third opening 135 a surface of semiconductor substrate 138 is visible, on which the channel of field effect transistor 100 is situated in a channel region 140. Channel region 140 has dimensions of 10 μm×100 μm, for example. A gate oxide 150 is situated in this channel region 140 (for example, on a substrate surface of the semiconductor substrate), as is customary for field effect transistors (FETs). Thus, the transition between gate oxide 150 and insulating layer 110, which is often also referred to as “field oxide,” adjoins this channel region 140 (in this case, shown outside the channel region). The edge angles of beveled side walls 137 of third opening 135 in field oxide 110 (i.e., the angles of beveled side walls 137 of third opening 135 in insulating layer 110) are in a range of 5° to 80°, for example. These edge angles of third opening 135 in insulating layer 110 may depend in particular on the properties of the coating material selected for manufacturing the FETs, for example wetting properties for a wet chemical coating.

The coatable surface area for contacting and/or forming the gate electrode (illustrated as transparent region 155 in FIG. 1) is then much larger, for example 1 mm×2 mm up to several square millimeters, than in conventional designs (in which only the channel region, which is usually several hundred square micrometers in size, is coated). In general, gate electrode 155 may also be referred to as a gate electrode layer 155, since this layer on the one hand represents the gate electrode itself, and on the other hand also represents the electronic printed conductor for contacting the gate electrode directly via the gate oxide. The much larger region for applying the gate electrode layer, resulting from use of the approach proposed here, simplifies the coating (i.e., forming gate electrode layer 155) and allows the use of cost-effective coating methods having a planar operating principle. Gate electrode layer 155 may be electrically contacted via a separate terminal contact 160.

Thus, as the result of the defined transition from gate oxide 150 to field oxide 110 and the defined properties of field oxide 110 in the edge region of beveled side walls 137, a surface area may be coated with sensitive coating 155 which is much larger than channel region 140 itself, the sensitive coating 155 itself extending beyond edges 137 on a surface of field oxide 110, visible in FIG. 1. This property of field oxide 110 allows a much simpler design compared to conventional gas-sensitive field effect transistors; thus, for example, the requirements for adjustment accuracy, for example for coating channel region 140, and also for implementing the boundary between a printed conductor and the channel region, are less demanding. Likewise, a simplified and improved mechanical and electrical connection is possible.

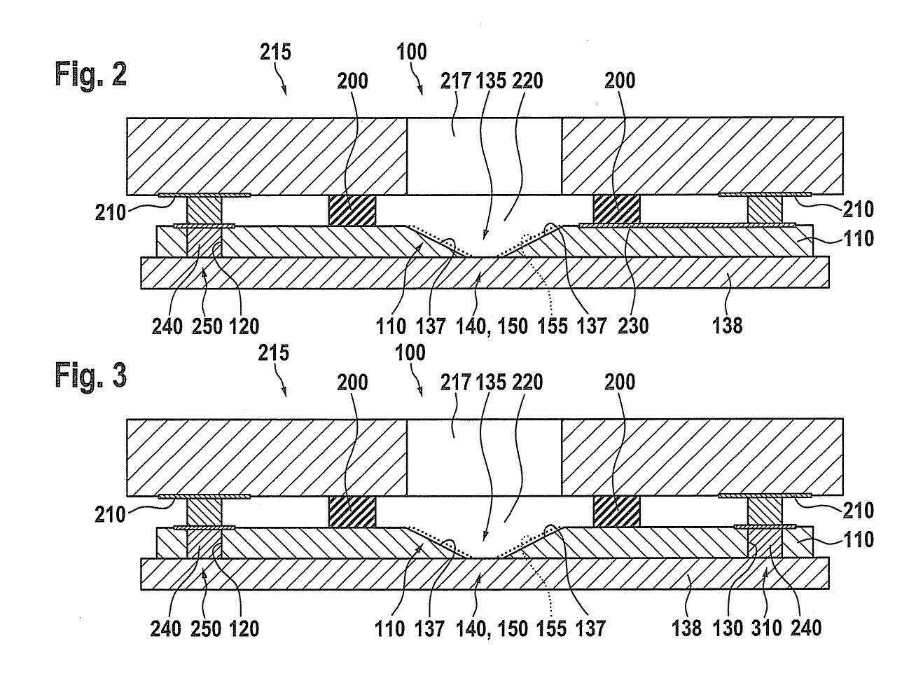

FIG. 2 shows a cross-sectional illustration of a semiconductor structure of a gas-sensitive field effect transistor 100 according to one exemplary embodiment of the present invention, illustrating a connection of CHEMFET 100 to a carrier substrate (or a housing) via a bond ring 200 and flip-chip contacts 210. FIG. 2 shows in particular an exemplary embodiment of assembly and connection technology which includes a bond ring 200 (which in this case is made of an insulating material, for example) and contacts 210 which allow flip-chip installation of processed CHEMFET 100 on a carrier substrate 215. Contacts 210 on carrier substrate 215 are formed by printed conductors 210, for example, which allow CHEMFET 100 to be contacted from outside a housing for CHEMFET 100.

Carrier substrate 215 also has, for example, a gas-permeable region 217 (in the form of an opening, for example) through which a gas to be measured passes to gas-sensitive gate electrode layer 155. When gas-permeable region 217 is subsequently applied to the carrier substrate (for example, in the form of a borehole having a filter (not illustrated in FIGS. 2 and 3) made of a porous ceramic, for example, which is subsequently inserted or mounted in this borehole), the sensitive coating may also be applied after connecting the CHEMFET die to carrier substrate 215 (having the borehole) and before inserting or mounting the filter. The filter, in addition to purely mechanical filtering (of particles, for example), may also have a chemical function, for example catalytic conversion, thus, for example, protecting the sensor function from interfering gases or at least reducing these gases. In this case the filter also acts as a catalyst.

A gas-accessible region 220 of sensor 100 is delimited by bond ring 200 in a fluid- and gas-tight manner. Thus, only the components necessary for measuring the gas concentration, in particular sensitive coating 155 on gate oxide or field oxide 155, are gas-accessible. Ideally, sensitive coating 155 may be implemented beneath bond ring 200; if this is not possible, a printed conductor 230 may also be implemented for contacting the sensitive coating beneath bond ring 200 (i.e., between bond ring 200 and the second surface of insulating layer 155), as illustrated in FIG. 2. Therefore, passivation for insulating contacts (or the like) is no longer absolutely necessary. Alternatively, a bond ring 200 may also be implemented from a conductive material. In such a case, sensitive layer 155 is contacted directly via bond ring 200, as illustrated in the cross-sectional illustration of a semiconductor structure of gas-sensitive field effect transistor 100 according to FIG. 3.

In addition, on the left side of FIGS. 2 and 3 it is apparent that terminal contacting 240 of source region 250 (or equivalently, also drain region 310 according to FIG. 3) of semiconductor substrate 138 may be carried out via flip-chip installation and associated printed conductors 210 as well as appropriate specialized openings 120 and 130 in insulating layer 110 (field oxide).

In summary, examples are given below for the design and in particular the material sequence of a CHEMFET semiconductor component 100 which may be used for exemplary embodiments of the present invention. A deposited and structured field oxide 110, for example composed of high temperature oxide (HTO) or produced from tetraethyl orthosilicate (TEOS), is situated on a semiconductor substrate 138 made of silicon carbide and having an implanted FET structure (typically contact regions, for example 250 and 310, channel region 140, substrate contact, and insulation region around the channel as a “guard”). At the locations not covered by field oxide 110, in particular at channel region 140, a gate oxide made of silicon carbide, for example, is present which is produced by (prior) oxidation, and which, either alone or in combination with another oxide, nitride, or carbide, provides the insulation of the channel on FET 100. This further insulation material may be a deposited silicon nitride or silicon oxynitride, for example, or silicon carbide or a layer which is deposited via atomic layer deposition, for example, and which is homogeneous or composed of alternating materials, for example aluminum oxide, titanium oxide, zirconium oxide, hafnium oxide, or tantalum oxide. A layer of undoped or doped amorphous silicon or polysilicon, for example, is deposited thereon and on portions of field oxide 110 as gate protection, for example; the layer may be compressed via a heat treatment step.

A printed conductor 230 composed, for example, of Ta, Ti, TiN as bonding agent and Pt or structurally stabilized Pt (a Pt—Rh alloy, for example) may be deposited on field oxide 110 and the gate protective layer. Printed conductor 230 may be structured either directly during the deposition (by lift-off, for example) or subsequently, for example by sputtering or ion beam etching. In these processes, the gate protective layer protects the gate from changes or erosion. One or multiple superposed passivation layers, for example made of deposited oxide, in particular TEOS or PECVD oxide, or silicon nitride, in this case in particular low-stress PECVD nitride, may be deposited over the resulting component, optionally once again using a bonding agent layer. Amorphous or polycrystalline silicon carbide may also be a component of this passivation layer. When the passivation layer is structured, once again the gate protective layer protects against changes in or attack of the gate insulation.

The gate protective layer may remain on the gate until just before the gate is coated with gate electrode layer 155, and may also protect against influences from finishing processes, for example sawing, separating, etc. When polysilicon is used, the gate protective layer (i.e., the gate protective layer still remaining after the structuring of the printed conductor and passivation) may be removed, for example, using a wet etching process (which has maximum selectivity for the gate insulating layer). A sensitive layer 155, for example nanostructured platinum, may then be deposited on the gate insulating layer thus exposed.

A sensor manufactured in this way may be advantageously used in a harsh environment, in particular in the exhaust gas system of a motor vehicle. One important target application is the measurement of nitrogen oxides in the measuring range of 1 to 100 ppm. In combination with other individual sensors having a different coating, at a different temperature, or downstream from a different filter material in gas-permeable region 217 of the carrier material, the selectivity and sensitivity to this target gas and to other gases may be increased. It is practical to combine these sensors in an array, for example, optionally in a common housing.

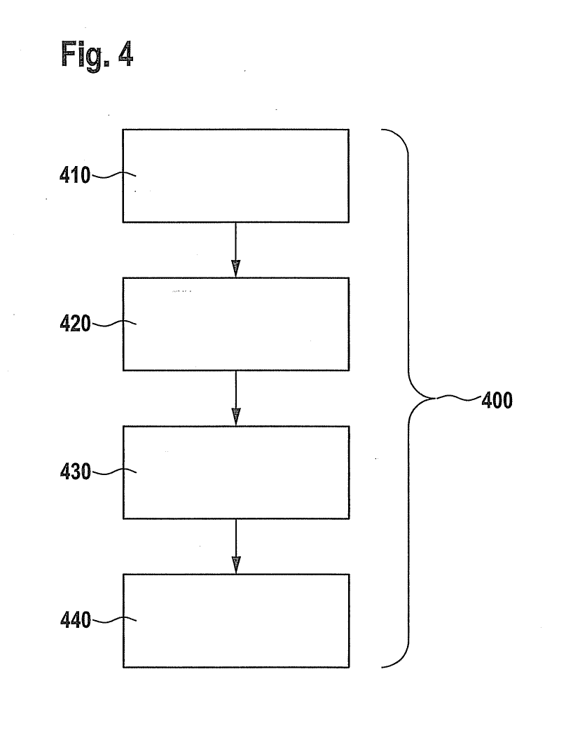

FIG. 4 shows a flow chart of one exemplary embodiment of the present invention as a method 400 for manufacturing a gas-sensitive field effect transistor, the method including a step of providing 410 a semiconductor substrate having a main substrate surface, the substrate having a source region, a gate region, and a drain region, and the main substrate surface being covered by an insulating layer. Method 400 also includes a step of applying 420 a masking layer to an exposed surface of the insulating layer, the masking layer being applied in such a way that it has a recess or opening having beveled side walls, and the recess or opening tapering toward a region oppositely situated from the gate region. Method 400 also includes a step of forming 430 an opening in the insulating layer or an insulating layer region having reduced layer thickness, using the recess or opening, in such a way that an opening or an insulating layer region having reduced layer thickness is formed in the insulating layer, the insulating layer having beveled side walls in the region of the opening or in the insulating layer region in such a way that a distance between oppositely situated beveled side edges of the insulating layer in the region of the opening in the insulating layer or in the insulating layer region decreases from a main surface of the insulating layer bordering the masking layer toward the main substrate surface. After this method step, the masking layer is removed, thus exposing a main surface of the insulating layer. Lastly, method 400 includes a step of applying 440 a gate electrode layer in order to cover at least a partial region of the exposed main surface of the insulating layer, at least one region of the beveled side walls of the opening in the insulating layer, and an area of the gate region with the gate electrode layer, the gate electrode layer including a material or a structuring which causes changes in the electrical properties of the gate electrode layer upon contact with a predefined gas.

Alternatively, in step 430 method 400 may include the deposition of a continuous layer (the gate insulating layer, for example) on the gate electrode layer. In step 440 a further continuous insulating layer is applied, in which an opening having beveled side walls is formed as described above. If the gate insulating layer is made of a different material than insulating layer 110, beveled side edges 137 in material 110 may be provided using a selective ablation method in which the gate insulating layer is subjected to little or no attack. The gate electrode layer may then be completed by applying a sensitive layer 155.

For providing the beveled side edges in material 110, it is particularly effective when the beveled edges are already implemented in a photoresist, using a reflow process on the exposed surface of insulating layer 110. This may be carried out in a very cost-effective manner using proven technologies for producing the masking layer. The opening in the insulating layer, with transfer of the beveled edges from the photoresist to material 110, may be produced very effectively using a dry etching step when, for example, a specified ratio of the ablation rates of photoresist and insulation material is set by adding oxygen to the etching gas.

What is claimed is:

1. A gas-sensitive field effect transistor, comprising:
a semiconductor substrate having a main substrate surface, a source region, a gate region, and a drain region;
an insulating layer which has a first main surface facing the main substrate surface, and a second main surface facing away from the main substrate surface, the insulating layer at least partially covering the main substrate surface, and having one of an opening or an insulating layer region having reduced layer thickness, in an area of the gate region, the insulating layer further having beveled side walls in a region of the one of the opening or the insulating layer region, in such a way that a distance between oppositely situated beveled side walls of the insulating layer in the region of the one of the opening or the insulating layer region decreases from the second main surface toward the first main surface; and
a gate electrode layer which covers at least a partial region of the first main surface of the insulating layer, a region of the beveled side walls, and an area of the gate region, the gate electrode layer including one of a material or a structuring which causes a change in electrical properties of one of the gate electrode layer or a surface thereof, upon contact with a predefined gas.

2. The gas-sensitive field effect transistor as recited in claim 1, wherein the insulating layer has beveled side walls which form an angle of 5 to 80 degrees with respect to one of the first or second main surface.

3. The gas-sensitive field effect transistor as recited in claim 1 wherein at least one of the source region, the drain region, and the gate electrode layer is electrically contacted using printed conductors which are applied to the second main surface of the insulating layer.

4. The gas-sensitive field effect transistor as recited in claim 1, wherein a bond ring is provided which is situated on a side of the insulating layer facing the second main surface of the insulating layer, and which surrounds the one of the opening or the insulating layer region having the reduced layer thickness.

5. The gas-sensitive field effect transistor as recited in claim 4, wherein the bond ring includes an electrically conductive material, and is used as an electrical contact for the gate electrode layer.

6. The gas-sensitive field effect transistor as recited in claim 1, further comprising:
a carrier substrate which, is situated one of: i) on a side facing the second main surface having the insulating layer using flip-chip technology, or ii) on a structure which is mounted on the insulating layer, the carrier substrate being designed to mechanically retain the field effect transistor.

7. The gas-sensitive field effect transistor as recited in claim 6, wherein the carrier substrate has an opening which is oppositely situated from the one of the opening in the insulating layer or in the insulating layer region having the reduced layer thickness.

8. The gas-sensitive field effect transistor as recited in claim 7, wherein the opening in the carrier substrate is closed using a gas-permeable filter material which filters a gas flowing through the opening in the carrier substrate.

9. The gas-sensitive field effect transistor as recited in claim 7, wherein the opening in the carrier substitute is closed using a catalyst material which catalyzes a gas flowing through the opening in the carrier substrate.

10. A method for manufacturing a gas-sensitive field effect transistor, comprising:
providing a semiconductor substrate having a main substrate surface, the semiconductor substrate having a source region, a gate region, and a drain region, the main substrate surface being covered by an insulating layer;
applying a masking layer to an exposed surface of the insulating layer, the masking layer being applied in such a way that it has one of a recess or opening having beveled side walls, the recess or opening tapering toward a region oppositely situated from the gate region;
forming one of an opening in the insulating layer or a region having reduced layer thickness in the insulating layer, using the one of recess or opening in the masking layer, in such a way that one of the opening or the insulating layer region having reduced layer thickness is formed in the insulating layer, the insulating layer having beveled side walls in the region of the one of the opening or in the insulating layer region, in such a way that a distance between oppositely situated beveled side walls of the insulating layer in the region of the one of the opening in the insulating layer or the insulating layer region having reduced thickness decreases, from a main surface of the insulating layer bordering the masking layer toward the main substrate surface; and
applying a gate electrode layer to cover at least a partial region of an exposed main surface of the insulating layer, at least a region of the beveled side walls in the insulating layer, and an area of the gate region through the gate electrode layer, the gate electrode layer including one of a material or a structuring which causes a change in electrical properties of the gate electrode layer upon contact with a predefined gas.

11. The method as recited in claim 9, wherein in the step of applying the masking layer, a photoresist having defined edge characteristics is applied as a masking layer to an exposed surface of the insulating layer using a reflow process, and in a structuring method, a structure of edges of photoresist is transferred to the edges of the insulating layer.
